(19) United States
(12) Patent Application Publication
(10) Pub. No.: US 2014/0078419 A1
(43) Pub. Date: Mar. 20, 2014

(54) TOUCH DISPLAY DEVICE AND TOUCH PANEL

(71) Applicants: WINTEK CORPORATION, Taichung City (TW); Dongguan Masstop Liquid Crystal Display Co., Ltd., Dongguan City (CN)

(72) Inventors: Jung-Sung Lin, Taichung City (TW); Hsua-Yun Lee, Taichung City (TW); Chien-Heng Chen, Taichung City (TW); Chia-Hung Pan, Taichung City (TW)

(73) Assignees: WINTEK CORPORATION, Taichung City (TW); Dongguan Masstop Liquid Crystal Display Co., Ltd., Dongguan City (CN)

(21) Appl. No.: 14/029,789

(22) Filed: Sep. 17, 2013

(30) Foreign Application Priority Data
Sep. 19, 2012 (TW) 101134250

(51) Int. Cl. G06F 1/16

(52) U.S. Cl. CPC G06F 1/1692
USPC 349/12

(57) ABSTRACT

A touch display device includes a touch panel and a display panel. The touch panel, having a photic region and a peripheral region adjacent to at least one edge of the photic region, includes a cover lens, a touch sensing unit, and an adhesive layer. The touch sensing unit is disposed on an inner surface of the cover lens and is at least partially disposed in the photic region. The adhesive layer covers the touch sensing units and extends to the peripheral region. The touch sensing unit is disposed between the adhesive layer and the cover lens. The display panel is disposed on a surface of the adhesive layer opposite to the cover lens. An area of the touch panel along a vertical projective direction is larger than an area of the display panel so as to at least partially expose the adhesive layer in the peripheral region.

### BACKGROUND OF THE INVENTION

1. Field of the Invention

The present invention generally relates to a touch display device and a touch panel, and more particularly, to a touch display device and a touch panel including an adhesive layer extending to a peripheral region so as to improve the resistance to electrostatic discharge.

2. Description of the Prior Art

Nowadays, mobile phones, GPS navigator system, personal digital, tablet PCs, assistants (PDA) and notebook PCs with touch functions are wildly used in modern life. In the above-mentioned electronic products, the touch display devices can be obtained by integrating the original display function with the touch sensing function. Nowadays, an out-cell touch display panel, which includes a display panel and a touch panel adhered to each other, is one of the mainstream development in the field of the touch display devices. Generally, the touch panels can be mainly divided into two types according to their structure, i.e. the glass/glass touch panels and the one glass solution (OGS) touch panels. In the glass/glass touch panel, since a touch sensing unit is formed on the cover glass directly, the total amount of glass substrate used in the glass/glass touch panel is reduced. Accordingly, the glass/glass touch panel can presents small form with simplified structure.

As shown in FIG. 1, in order to form a conventional touch display panel 100, a one glass solution touch panel 110 can be coupled to a liquid crystal panel 120 by an adhesive layer 130. The liquid crystal panel 120 and the adhesive layer 130 are disposed on an inner surface 110B of the one glass solution touch panel 110 opposite to a touch surface 110A. Since the size of the adhesive layer 130 is normally equal to the size of a polarizing film 121 of the liquid crystal panel 120, the inner surface 110B of the one glass solution touch panel 110 located in a peripheral region will be exposed. In this configuration, when static electricity is generated from or above the touch display panel 100, it will easily attack the devices disposed in the one glass solution touch panel 110 through the exposed inner surface 110B and can reduce the reliability of the corresponding product.

### SUMMARY OF THE INVENTION

One objective of the present invention is to provide a touch display device and a touch panel. An adhesive layer may extend to a peripheral region of the touch panel so as to improve the resistance to electrostatic discharge.

To this end, a touch display device is provided. The touch display device includes a touch panel and a display panel. The touch panel has a photic region and a peripheral region disposed on at least one edge of the photic region. The touch panel includes a cover lens, a touch sensing unit, and an adhesive layer. The cover lens has a touch surface and an inner surface opposite to the touch surface. The touch sensing unit is disposed on the inner surface of the cover lens and is disposed in the photic region. The adhesive layer covers the touch sensing unit and extends to the peripheral region. The touch sensing unit is disposed between the adhesive layer and the cover lens. The display panel is disposed on a surface of the adhesive layer opposite to the cover lens. An area of the touch panel along a vertical projective direction is larger than an area of the display panel so as to at least partially expose the adhesive layer in the peripheral region.

According to another embodiment of the present invention, a touch panel is provided. The touch panel has a photic region and a peripheral region disposed on at least a side of the photic region. The touch panel includes a cover lens, a touch sensing unit, and an adhesive layer. The cover lens has a touch surface and an inner surface opposite to the touch surface. The touch sensing unit is disposed on the inner surface of the cover lens and disposed in the photic region. The adhesive layer is disposed on the inner surface of the cover lens. The adhesive layer covers the touch sensing unit and extends to the peripheral region, and the touch sensing unit is disposed between the adhesive layer and the cover lens.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic cross-sectional diagram showing a structure of conventional touch liquid crystal display panel.

FIG. 2 is a schematic cross-sectional diagram showing a touch panel according to a first preferred embodiment of the present invention.

FIG. 3 is a schematic top view showing a touch panel according to a first preferred embodiment of the present invention.

FIG. 4 is a schematic top view showing a touch panel according to a second preferred embodiment of the present invention.

FIG. 5 is a schematic top view showing a touch panel according to a third preferred embodiment of the present invention.

FIG. 6 is a schematic cross-sectional diagram showing a touch panel according to a fourth preferred embodiment of the present invention.

FIG. 7 is a schematic cross-sectional diagram showing a touch display device according to a fifth preferred embodiment of the present invention.

FIG. 8 to FIG. 10 are schematic diagrams showing processes for manufacturing a touch display device according to a fifth preferred embodiment of the present invention.

FIG. 11 is a schematic cross-sectional diagram showing a touch display device according to a sixth preferred embodiment of the present invention.

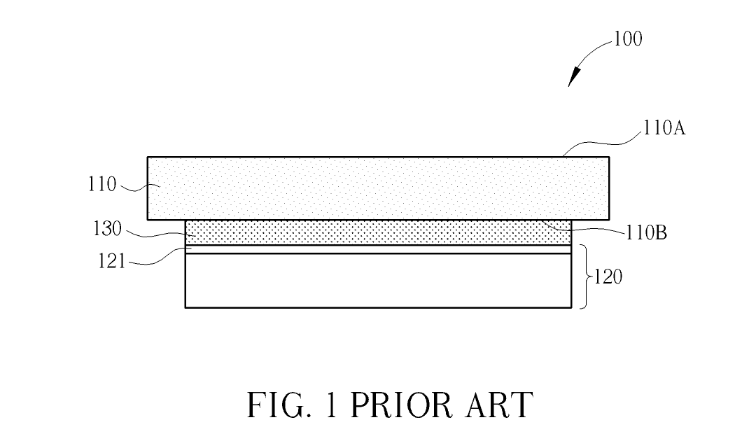

### DETAILED DESCRIPTION

To provide a better understanding of the present invention to those skilled in the technology of the present invention, various preferred embodiments will be detailed as follows. The preferred embodiments of the present invention are illustrated in the accompanying drawings with numbered elements to elaborate the contents and effects to be achieved.

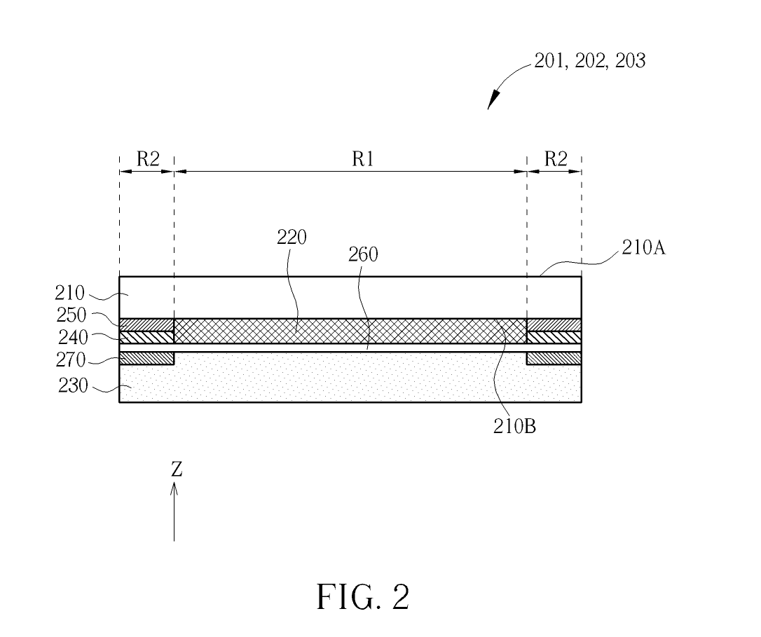

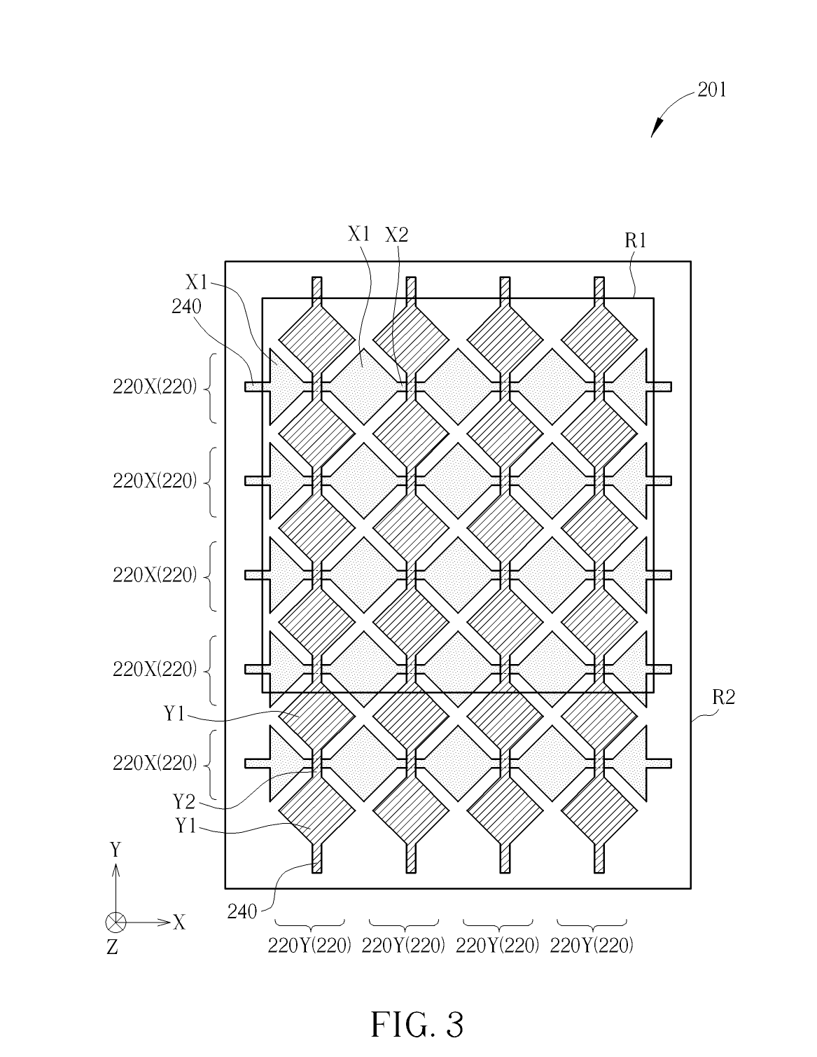

A shown in FIG. 2 and FIG. 3, a touch panel 201 according to a first preferred embodiment of the present invention have a photic region R1 and a peripheral region R2. The peripheral region R2 is disposed on at least a side of the photic region R1. In this embodiment, the peripheral region R2 surrounds the photic region R1, but not limited thereto. According to specific requirements, the peripheral region R2 may be disposed adjacent to a portion edge of the photic region R1 if required. The touch panel 201 includes a cover lens 210, a touch sensing unit 220 and an adhesive layer 230. The cover lens 210 has a touch surface 210A and an inner surface 210B opposite to the touch surface 210A. The touch sensing unit 220 is disposed on the inner surface 210B of the cover lens 210, and the touch sensing unit 220 is at least disposed in the photic region R1 and can extend to the peripheral region R2. The adhesive layer 230 is also disposed on the inner surface 210B of the cover lens 210. The adhesive layer 230 may cover the touch sensing unit 220 and extend to the peripheral region R2.

To put it more concretely, the touch panel 201 may further include a conductive line 240 on the inner surface 210B of the cover lens 210 for electrically connecting to the touch sensing unit 220. At least a portion of the conductive line 240 is disposed in the peripheral region R2 for being electrically connected to a control unit (not shown in FIGS. 2 and 3) and transmitting signals, but not limited thereto. In this embodiment, the composition of the conductive line 240 may include metal materials, such as silver (Ag), aluminum (Al), copper (Cu), magnesium (Mg) and molybdenum (Mo), or transparent conductive materials, such as indium tin oxide (ITO), indium zinc oxide (IZO), aluminum zinc oxide (AZO), a composition layer thereof or an alloy thereof, but not limited thereto. Additionally, the touch panel 201 may further include a decoration layer 250, a protection layer 260 and a shielding layer 270. The decoration layer 250 and the shielding layer 270 are disposed in the peripheral region R2. The protection layer 260 is disposed between the adhesive layer 230 and the touch sensing unit 220 so as to protect the touch sensing unit 220, but not limited thereto. The adhesive layer 230 disclosed in the present embodiment extends from the photic region R1 to the peripheral region R2. Since the adhesive layer 230 covers the conductive line 240, the decoration 250, the protection layer 260 and the shielding layer 270 along a vertical projection direction Z substantially perpendicular to the cover lens 210, the resistance to the electrostatic discharge (ESD) of the touch panel 201 in the peripheral region R2 can be improved. Therefore, the devices located in the peripheral region R2, such as the conductive line 240, will no longer be attacked by the static electricity and the reliability of the touch panel 201 is improved. The adhesive layer 230 preferably includes an optical clear adhesive (OCA), a pressure sensitive adhesive (PSA) or other materials suitable for adhering and improving the resistance to electrostatic discharge. The cover lens 210 disclosed in this embodiment preferably include a rigid cover lens, such as a cover glass, or a flexible cover lens, such as a plastic cover lens, or other cover lenses made of suitable materials. The manufacturing processes for the touch panel 201 disclosed in the present invention may include first forming the touch sensing unit 220 and the conductive line 240 on the inner surface 210B of the cover lens 210. The adhesive layer 230 is then formed to cover the touch sensing unit 220 located in the photic region R1 and the conductive line 240 in the peripheral region R2. In other words, the touch sensing unit 220 is disposed between the adhesive layer 230 and the cover lens 210. The adhesive layer 230 preferably covers the entire photic region R1 and the peripheral region R2, but not limited to thereto. The adhesive layer 230 may cover a portion of the peripheral region R2, if needed, to achieve the required resistance to electrostatic discharge. Additionally, the touch panel 201 disclosed in this embodiment may be regarded as a one glass solution (OGS) touch panel, but not limited to this.

As shown in FIG. 3, the touch sensing unit 220 disclosed in this embodiment preferably includes a plurality of first axis electrodes 220X and a plurality of second axis electrodes 220Y disposed across from one another. Each first axis electrode 220X extends along a first direction X and each second axis electrode 220Y extends along a second direction Y. Besides, the first direction X is preferably substantially perpendicular to the second direction Y, but not limited thereto. Each first axis electrode 220X includes a plurality of first sensing electrodes X1 and a plurality of first conductive lines X2 disposed in the photic region R1, and each second axis electrode 220Y includes a plurality of second sensing electrodes Y1 and a plurality of second conductive lines Y2 disposed in the photic region R1. Preferably, the first sensing electrodes X1 and the second sensing electrodes Y1 are uniformly distributed within the photic region R1 so as to perform the touch sensing function. The function of the first conductive lines X2 and the second conductive lines Y2 is to respectively electrically connect the first sensing electrodes X1 in the same first axis electrode 220X and electrically connect the second sensing electrodes Y1 in the same second axis electrode 220Y. Preferably, the first conductive lines X2 and the second conductive lines Y2 may extend into the peripheral region R2 so that they can be electrically connected to a control unit (not shown in FIG. 3), but not limited thereto.

In the following paragraph, various embodiments are disclosed and the description of these embodiments is mainly focused on differences among one another. In addition, like or similar features will usually be described with same reference numerals for ease of illustration and description thereof.

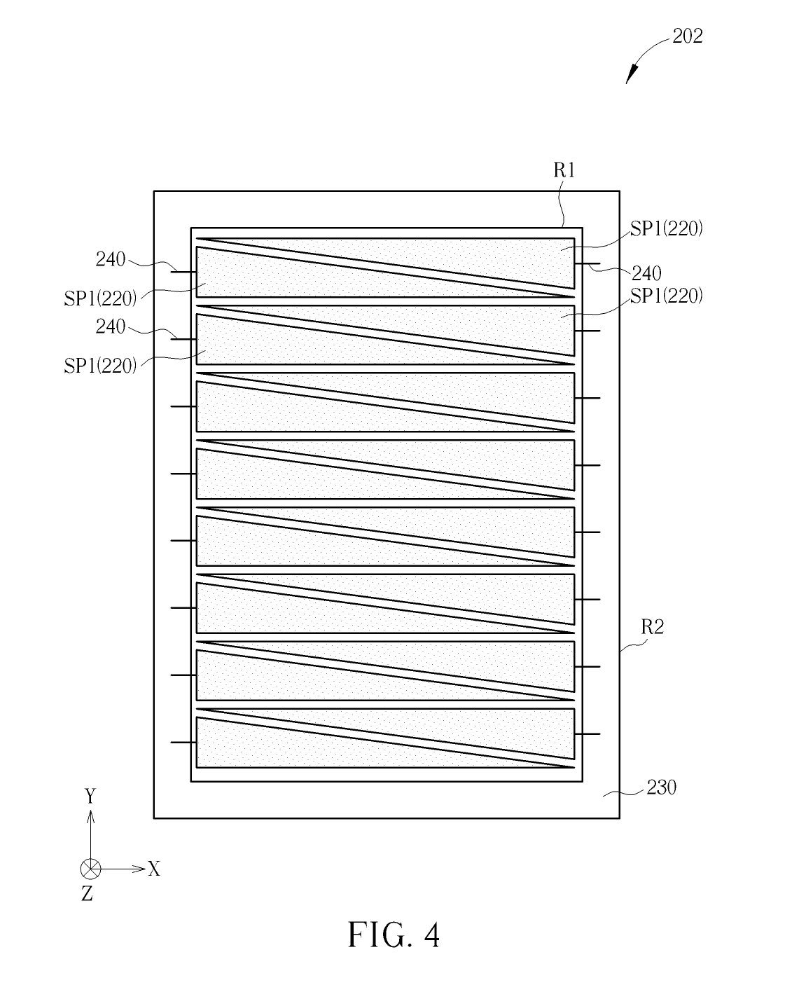

As shown in FIG. 4 and FIG. 2, a touch panel 202 is provided in a second preferred embodiment of the present invention. One main difference between the first preferred embodiment and the present embodiment is that the touch sensing unit 220 disposed in the touch panel 202 preferably includes a plurality of sensing electrodes SP1. These sensing electrodes SP1 are separately disposed within the photic region 290 in order to carry out touch sensing functions. Additionally, the touch sensing unit 220 may further include a plurality of conductive lines 240 respectively connected to each sensing electrode SP1. Preferably, each conductive line 240 may extend to the peripheral region R2 for being electrically connected to a control unit (not shown in FIGS. 2 and 4), but not limited thereto. Apart from the existence of the sensing electrodes SP1, the rest of the parts in the touch panel 202 disclosed in this embodiment, as well as the characteristics of other parts, disposed positions and material properties are almost similar to those described in the previous preferred embodiment. For the sake of brevity, these similar configurations and properties are therefore not disclosed in detail. It is worth noting that each of the sensing electrodes SP1 disclosed in the present embodiment preferably has a triangular shape, but not limited thereto. That is to say, each sensing electrodes SP1 can have shapes different from the triangular shape and the sensing electrodes SP1 can be uniformly distributed within the photic region R1 so as to achieve the required touch sensing function.

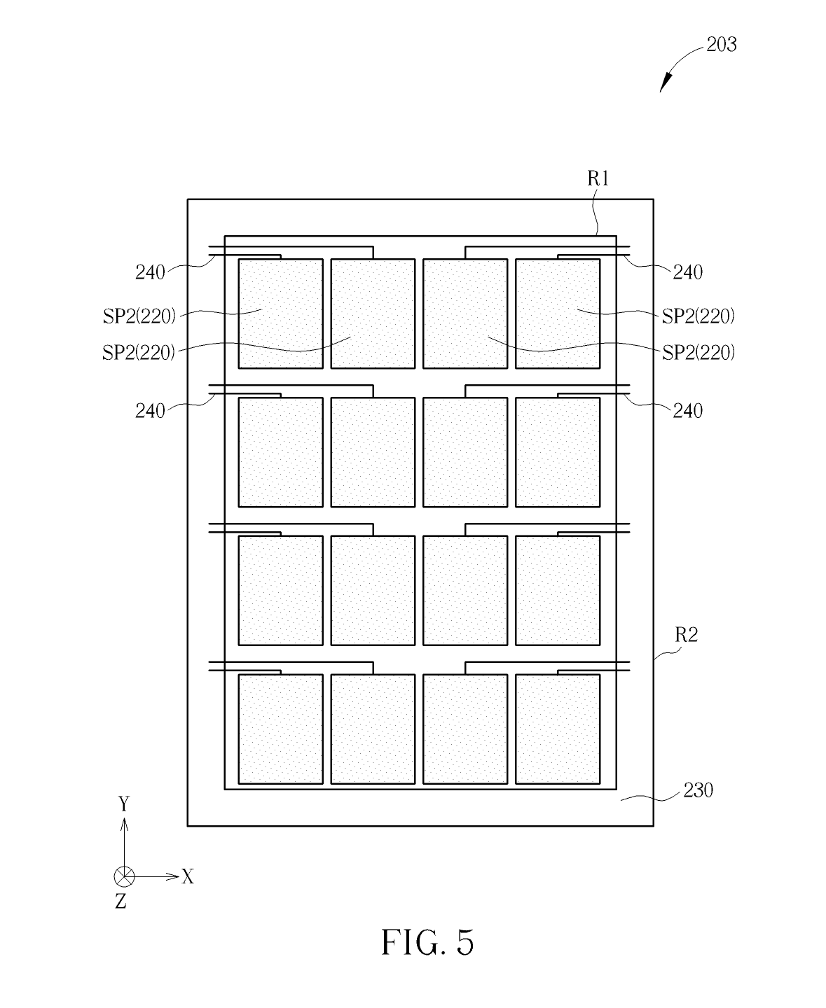

As shown in FIG. 5 and FIG. 2, a touch panel 203 is provided in a third preferred embodiment of the present invention. According to the present embodiment, a touch sensing unit 220 disposed in the touch panel 203 preferably includes a plurality of sensing electrodes SP2. These sensing electrodes SP2 are separately disposed within the photic region R1 and have touch sensing abilities. It is worth noting that each of the sensing electrodes SP2 disclosed in the present embodiment preferably has a rectangular shape, but not limited thereto. That is to say, sensing electrodes SP2 can have different shapes, like regular or irregular shapes, and the sensing electrodes SP2 can be uniformly distributed within the photic region R1 so as to achieve the required touch sensing function.

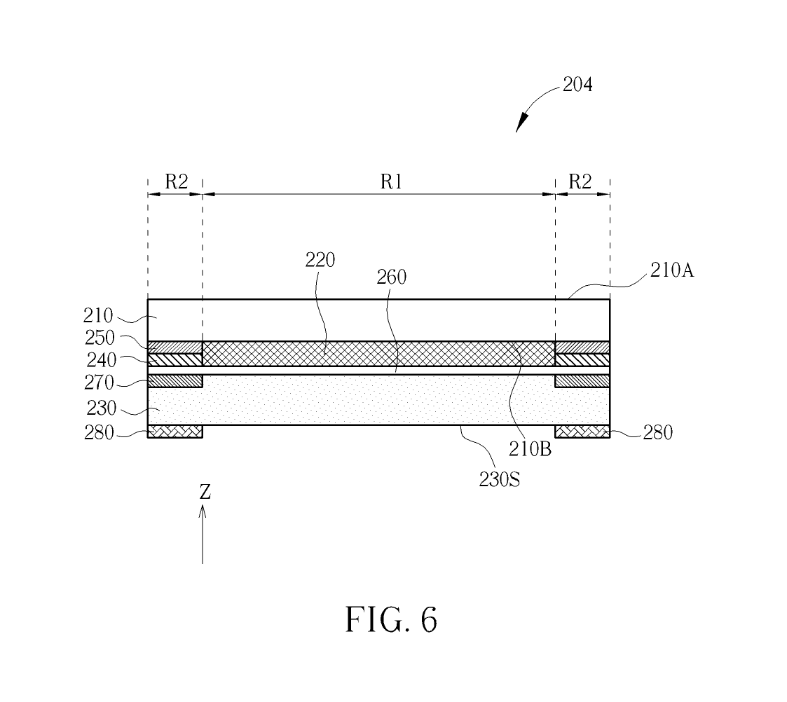

As shown in FIG. 6, a touch panel 204 is provided according to a fourth embodiment of the present invention, one difference between this embodiment and the touch panel 201 disclosed in the previous first preferred embodiment is that the touch panel 204 further includes a release film 280 disposed on a surface 230S of the adhesive layer 230 opposite to the cover lens 210. Preferably, the release film 280 is disposed in the peripheral region R2 so that it can prevent the surface 230S of the adhesive layer 230 from being exposed and contacted with dust. In addition, the resistance to the electrostatic discharge can also be improved. Apart from the existence of the release film 280, the rest of the parts in this embodiment, as well as the characteristics of other parts, disposed positions and material properties are almost similar to those described in the previous first preferred embodiment. For the sake of brevity, these similar configurations and properties are therefore not disclosed in detail. It is worth noting that the surface 230S of the adhesive layer 230 not covered by the release film 280 is preferably used to adhere to other devices, such as display panel (not shown in FIG. 6). Therefore, the shape and the size of the release film 280 are preferably designed corresponding to the shape of the adhered-device so as to achieve required protection properties, but not limited to this. The release film 280 may preferably include polyethylene terephthalate (PET), polyethersulfone (PES), polyimide (PI), polycarbonate (PC), polyethylene naphthalate (PEN), polymethyl methacrylate (PMMA) or other suitable materials.

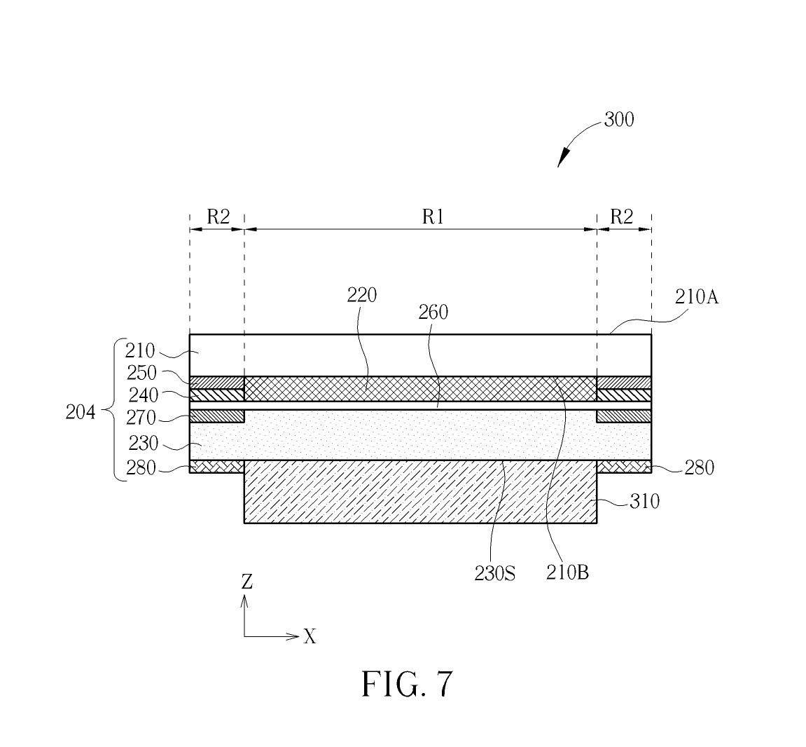

As shown in FIG. 7, a touch display device 300 is provided according to a fifth embodiment of the present invention. The touch display device 300 includes a touch panel 204 and a display panel 310. The structure of the touch panel 204 and the characteristic of each part are almost similar to those described in the previous preferred embodiments. For the sake of brevity, these similar configurations and properties are therefore not disclosed in detail. In the touch display device 300, the display panel 310 is disposed on the surface 230S of the adhesive layer 230 opposite to the cover lens 210. The adhesive layer 230 is used to have the touch panel 204 adhered to the display panel 310. The display panel 310 covers the adhesive layer 230 located in the photic region R1 along the vertical projection direction Z. The area of the touch panel 204 along the vertical projection direction Z is larger than the area of the display panel 310. To put it more concretely, according to the present embodiment, the adhesive layer 230 not covered by the display panel 310 is preferably covered by the release film 280 so as to improve the resistance to electrostatic discharge. In other words, the release film 280 preferably surrounds at least a side of the display panel 310 in a direction parallel to the cover lens 210, such as in a first direction X. The display panel 310 disclosed in the present embodiment preferably includes a liquid display panel, an organic light emitting diode (OLED) display panel, an electro-wetting display panel, an e-ink display panel, a plasma display panel or a field emission display (FED) panel, but not limited thereto.

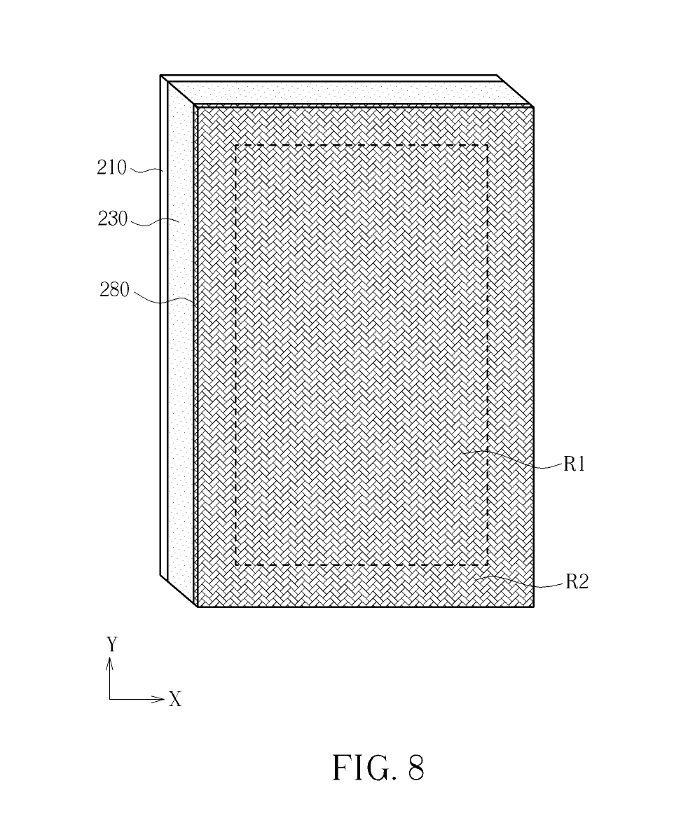

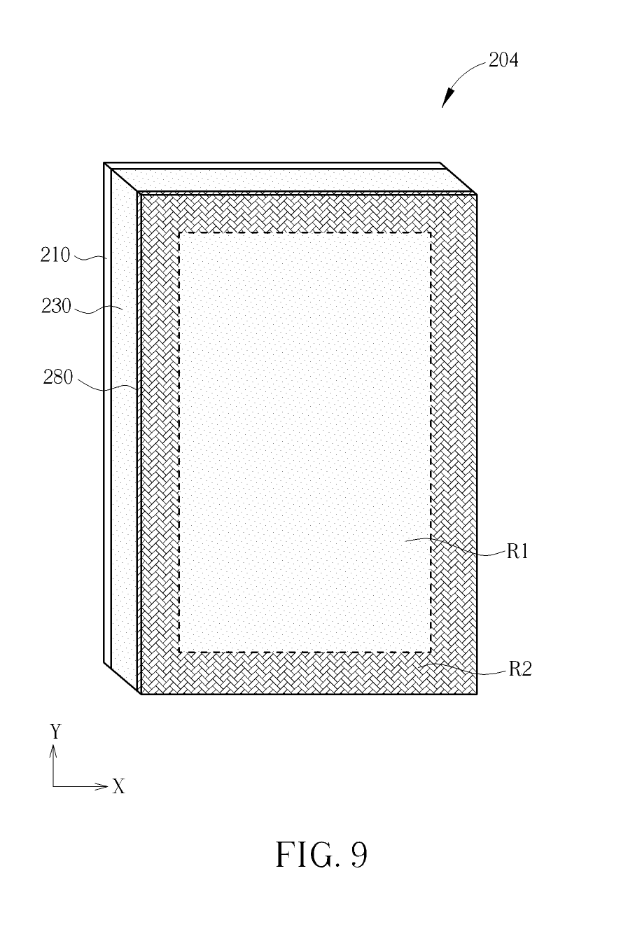

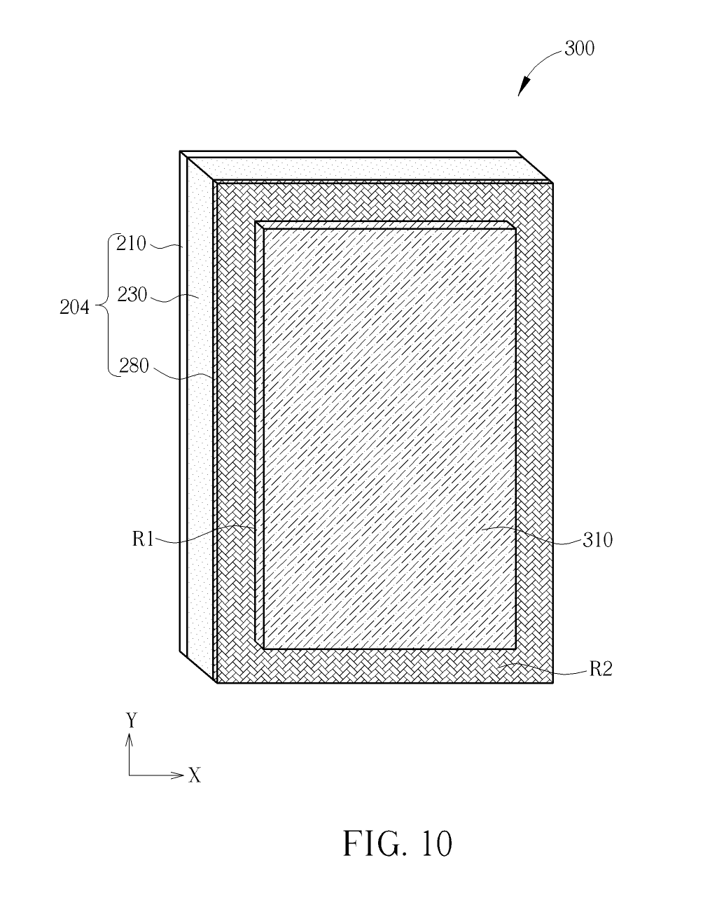

The manufacturing processes for the touch display device 300 disclosed in the present invention may include the following steps. First, as shown in FIG. 8, the adhesive layer 230 and the release film 280 are formed on the cover lens 210 sequentially. The adhesive layer 230 and the release film 280 preferably cover the entire cover lens 210; that is to say, the photic region R1 and the peripheral region R2 are covered by the adhesive layer 230 and the release film 280 concurrently, but not limited thereto. Then, as shown in FIG. 9, the release film 280 located in the photic region R1 is removed so that the adhesive layer 230 in the photic region R1 is exposed. Accordingly, the touch panel 204 disclosed in the previous fourth preferred embodiment (as shown in FIG. 6) is obtained. Subsequently, as shown in FIG. 10, the display panel 310 is adhered to the touch panel 204 in order to form the touch display device 300. The above mentioned adhesive layer 230 and the release film 280 may preferably be formed on the cover lens 210 through adhering processes or coating processes, but not limited thereto. One advantage of the present embodiment is that the cost for manufacturing the touch display device 300 will not be increased since there is no extra process required for manufacturing the touch display device 300.

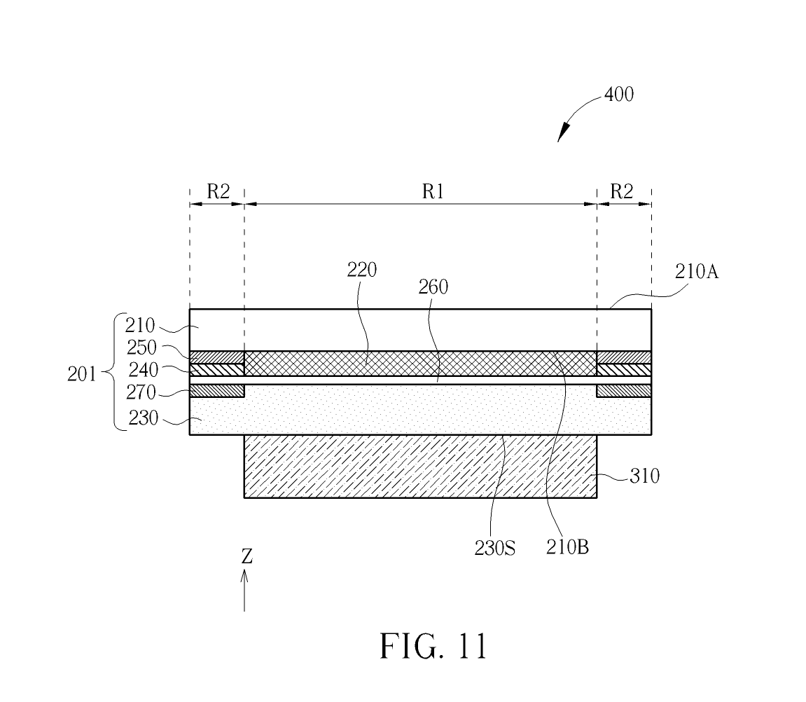

As shown in FIG. 11, a touch display device 400 is provided in a sixth preferred embodiment of the present invention. One main difference between the fifth preferred embodiment and the present embodiment is that the touch display device 400 includes a touch panel 201 and a display panel 310. In other words, the touch display device 400 does not include a release film. The display panel 310 covers the adhesive layer 230 in the photic region R1 along the vertical projection direction Z and exposes the adhesive layer 230 in the peripheral region R2. Apart from the absence of the release film, the rest of the parts in the touch display device 400 disclosed in this embodiment, as well as the characteristics of other parts, disposed positions and material properties are almost similar to those described in the previous fifth preferred embodiment. For the sake of brevity, these similar configurations and properties are therefore not disclosed in detail.

To summarize, the touch display device and the touch panel disclosed in the present invention include the adhesive layer extending to the peripheral region of the touch panel so that the resistance to electrostatic discharge is improved. Furthermore, since the release film is disposed on a portion of the adhesive layer to prevent the adhesive layer from being exposed and contacted with dust, the appearance of the device and the panel, and the resistance to the electrostatic discharge can all be improved accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch display device, comprising:
a touch panel, having a photic region and a peripheral region disposed on at least one side of the photic region, the touch panel comprising:
a cover lens, having a touch surface and an inner surface opposite to the touch surface;
a touch sensing unit, disposed on the inner surface of the cover lens, wherein the touch sensing unit is at least partially disposed in the photic region; and
an adhesive layer, disposed on the inner surface of the cover lens, wherein the adhesive layer covers the touch sensing unit and extends to the peripheral region, and the touch sensing unit is disposed between the adhesive layer and the cover lens; and
a display panel, disposed on a surface of the adhesive layer opposite to the cover lens, wherein an area of the touch panel is larger than an area of the display panel along a vertical projection direction so as to at least partially expose the adhesive layer in the peripheral region from the display panel.

2. The touch display device of claim 1, wherein the adhesive layer is used to have the touch panel adhere to the display panel, and the display panel covers the adhesive layer in the photic region along the vertical projection direction and exposes the adhesive layer in the peripheral region.

3. The touch display device of claim 2, wherein the touch panel further comprises a release film disposed on the surface of the adhesive layer opposite to the cover lens, and the display panel not covered by the adhesive layer is covered by the release film.

4. The touch display device of claim 3, wherein the release film surrounds at least a side of the display panel in a direction parallel to the cover lens.

5. The touch display device of claim 1, wherein the touch panel further comprises at least a conductive line disposed on the inner surface of the cover lens, the conductive line is electrically connected to the touch sensing unit, and the adhesive layer covers the conductive line in the peripheral region.

6. The touch display device of claim 1, wherein the adhesive layer comprises an optical clear adhesive (OCA) or a pressure sensitive adhesive (PSA).

7. The touch display device of claim 1, wherein the touch sensing unit comprises a plurality of first axis electrodes and a plurality of second axis electrodes disposed across from one another.

8. The touch display device of claim 1, wherein the touch sensing unit comprises a plurality of sensing electrodes disposed separately.

9. The touch display device of claim 1, wherein the display panel comprises a liquid crystal display panel, an organic light emitting diode (OLED) display panel, an electro-wetting display panel, an e-ink display panel, a plasma display panel or a field emission display (FED) panel.

10. The touch display device of claim 1, further comprising a decoration layer disposed on the cover lens.

11. The touch display device of claim 10, wherein the decoration layer is disposed in the peripheral region.

12. The touch display device of claim 1, wherein the cover lens is a rigid cover lens or a flexible cover lens.

13. The touch display device of claim 1, wherein the touch sensing unit extends to the peripheral region.

14. A touch panel, having a photic region and a peripheral region disposed on at least a side of the photic region, the touch panel comprising:
a cover lens, having a touch surface and an inner surface opposite to the touch surface;
a touch sensing unit, disposed on the inner surface of the cover lens and disposed in the photic region; and
an adhesive layer, disposed on the inner surface of the cover lens, wherein the adhesive layer covers the touch sensing unit and extends to the peripheral region, and the touch sensing unit is disposed between the adhesive layer and the cover lens.

15. The touch panel of claim 14, further comprising a release film disposed on a surface of the adhesive layer opposite to the cover lens, wherein the release film is disposed in the peripheral region.
